(19) United States
(12) Patent Application Publication
(10) Pub. No.: US 2021/0302922 A1
(43) Pub. Date: Sep. 30, 2021

(54) ARTIFICIALLY INTELLIGENT MECHANICAL SYSTEM USED IN CONNECTION WITH ENABLED AUDIO/VIDEO HARDWARE

(71) Applicant: MeetKai, Inc., Marina Del Rey, CA (US)

(72) Inventors: Adam Joosten, Marina Del Rey, CA (US); James Kaplan, Marina Del Rey, CA (US)

(21) Appl. No.: 17/214,625

(22) Filed: Mar. 26, 2021

Related U.S. Application Data
(60) Provisional application No. 63/000,429, filed on Mar. 26, 2020.

(51) Int. Cl. G05B 13/02; G06F 3/01; G10L 15/22

(52) U.S. Cl. CPC G05B 13/0265; G10L 15/22; G06F 3/011

(57) ABSTRACT

A device and method to move user interacting devices responsive to user input using artificial intelligence. The device includes a movable mount for supporting the user interacting device. User input is converted into service requests using artificial intelligence services. The device converts the service requests into movement commands, which it may then execute. The user interacting device may receive and process user input into service requests or the devices itself may be configured with artificial intelligence services. The device then converts into movement commands by imparting motion on the movable base through use of one or more motors or other movement generating devices.

### 1. CROSS-REFERENCE TO RELATED APPLICATION

This application claims priority to and incorporates by reference in its entirety U.S. Provisional Application No. 63/000,429, which was filed on Mar. 26, 2020.

### 2. FIELD OF THE INVENTION

The invention relates to the utilization of an artificially intelligent mechanical arm to enhance a user's experience through a video screen.

### 3. BACKGROUND

Prior art systems typically utilize one of the two methodologies for device holders and movement. The first uses pre-programmed mechanical arm devices. Such a device could be referenced from a video camera on a tripod that rotates 360 degrees over a period of time. This device has the ability to be pre-programmed to rotate at a fixed speed and rate. This device does not have the ability to follow a user through audio feedback.

The second methodology follows users as they move through a video frame such as on a fixed security camera. This device could be referenced as a security camera that follows a user as they walk in and out of frame. This device is programmed to detect movement of a person as they walk or run and then has the ability to follow the movement of a user as they move around. This device also does not have the ability to follow a user based on audio feedback.

### SUMMARY

This innovation provides advantages over the prior art methodologies by utilizing artificial intelligence through audio and visual cues to enhance user experience and control the mechanical arm (hereafter arm). The arm's artificial intelligence uses both audio and video to help guide the user experience. This enhancement is imperative for smart video to help bridge the technology gap between in-person domains and on-device domains. An in-person domain is defined as a category or activity a user does in person. This could be cooking, playing a video game, or being inside a classroom at school. Since this domain happens in the real-world, a user has free will and free range of motion to see all angles and to be fully immersed in the experience. This enhancement uses audio and/or visual cues from the user and enables the video screen to follow a user while they move.

With an ever-growing market of technology and innovation, the combination of an artificially intelligent mechanical arm with full range of motion and video and audio cues greatly enhances all prior art systems and methods. An artificially intelligent mechanical arm that learns, understands, and can provide instant user feedback is what separates this mechanical arm apart from the prior art.

To overcome the drawbacks of the prior art and provide additional advantages, disclosed is an artificial intelligence mechanical device. In one embodiment, the device includes a clasp, configured to support a user interacting device and to expand and collapse against the user interacting device such that the user interacting device is removable from the clasp. The user interacting device is configured to receive a user input from a user and convert the user input to a service request using artificial intelligence services operating on the user interacting device. A movable mount is connected to the clasp such that the movable mount has one or more motors configured impart motion to the movable mount and the user interacting device. A memory is configured with non-transitory machine executable code while a processor is configured to execute the machine executable code stored on the memory. The machine executable code is configured to receive the service request via a communication link, convert the service request into movement commands, and execute the movement commands using the imparted motion to satisfy the service request.

In one embodiment, the clasp is mounted on a multi-joint mechanical arm configured to impart motion along one or more different movement axis. The user interacting device may comprise a smartphone, a tablet, a laptop, a personal computer, or a computing device. It is also contemplated that the device may further comprise a user interface to receive a second user input, and the machine executable code is further configured convert the second user input to a second service request and convert the second service request into movement commands.

In one embodiment, the artificial intelligence services comprise one or more of image modelling, text modelling, forecasting, planning, making recommendations, performing searches, processing speech into service requests, processing audio into service requests, processing video into service requests, processing image into service requests, facial recognition, motion detection, motion tracking, generating audio, generating text, generating image, and generating video. The user input may in an audio format or a video format. The user input may be in a video format received via a camera of the user interacting device and the imparted motion may comprise moving the user interacting device such that a screen of the user interacting device faces the user as the user moves in relation to the camera.

Also disclosed is a method of controlling the movement of a user interacting device using artificial intelligence. This method may include receiving a user input from a user to a user interacting device, converting the user input to a service request using artificial intelligence services, converting the service request into movement commands, and executing the movement commands to move the user interacting device to satisfy the service request.

The step of executing the movement commands to satisfy the service may comprising causing movement along at least a first movement axis and a second movement axis. This method may further comprise executing the movement commands by moving the user interacting device such that a screen of the user interacting device faces the user as the user moves in relation to a camera of the user interacting device. In one embodiment, this method also executes the movement commands by moving the user interacting device such that the user interacting device mirrors the user's movement. The artificial intelligence services may comprise one or more of image modelling, text modelling, forecasting, planning, making recommendations, performing searches, processing speech into service requests, processing audio into service requests, processing video into service requests, processing image into service requests, facial recognition, motion detection, motion tracking, generating audio, generating text, generating image, and generating video.

Also disclosed herein is an artificial intelligence mechanical control device, for use with a user interacting device, comprising a movable mount, for supporting the user interacting device, on a base such that the base has one or more motors, configured impart motion to the movable mount and the user interacting device. This device also includes a user interface configured to receive input from a user and provide results to the user and a memory within the artificial intelligence mechanical control device configured with non-transitory machine executable code. A processor within the artificial intelligence mechanical control device is configured to execute the machine executable code stored on the memory, the machine executable code configured to convert the input from the user to a service request, convert the service request into movement commands, and execute the movement commands to move the movable mount, using the one or more motors, to satisfy the service request.

In one embodiment, the device further comprises a clasp, configured to support the user interacting device, the clasp configured to expand and collapse against the user interacting device such that the user interacting device is removable from the clasp. The clasp may be mounted on a multi-joint mechanical arm such that the multi-joint mechanical arm capable of movement along a first movement axis and a second movement axis. In one configuration, the movable mount is configured to move the user interacting device in two different axis of movement. The user interacting device may be permanently connected to the movable mount. The input may be in an audio format or a video format. In one embodiment, the input is in a video format received via a camera of the user interacting device, and the devices moves a screen of the user interacting device to face the user as the user moves in relation to the camera to satisfy the service request.

### DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates attachment mechanism of the artificially intelligent mechanical arm system.

FIG. 2 illustrates the Y-axis movement of the artificially intelligent mechanical arm system utilizing a range of motion of 180 degrees.

FIG. 3 illustrates the X-axis movement of the artificially intelligent mechanical arm system utilizing a range of motion of 180 degrees.

FIG. 4 illustrates the X-axis movement of the artificially intelligent mechanical arm system utilizing a range of motion of 360 degrees.

FIG. 5 illustrates a block diagram of the components of one example embodiment of the artificially intelligent mechanical arm system.

FIG. 6 illustrates an example environment of the use of the artificially intelligent mechanical arm system.

FIG. 7 illustrates an example software module layout of the artificially intelligent mechanical arm system and its attached user interacting device.

FIG. 8A illustrates the artificially intelligent mechanical arm system's single-user interaction capabilities using the example of a smart video device.

FIG. 8B illustrates the artificially intelligent mechanical arm system's multi-user interaction capabilities using the example of two user interacting with a smart video device.

FIG. 9 illustrates a flow diagram of an example method of use of the artificially intelligent mechanical arm system.

FIG. 10 illustrates a flow diagram of an example communication between the artificially intelligent mechanical arm system, an attached user interacting device, and other devices or cloud programs or servers.

FIG. 11 illustrates a block diagram of an exemplary user device.

FIG. 12 illustrates an example embodiment of a computing, mobile device, or server in a network environment.

### DETAILED DESCRIPTION

### Glossary of Terms

Artificial Intelligence (“AI”) services: Services provided using artificial intelligence processing and/or machine learning as to provided additional and interactive processing and functionality to existing systems. Examples could include image modelling, text modelling, forecasting, planning, making recommendations, performing searches, speech processing, audio processing, audio generation, text generation, image generation, and many more.

Device: Any element running with a minimum of a network controller and a CPU. Optionally, an accelerator can be attached in the form of a GPU or other specialized hardware accelerator. This accelerator can speed up the computing of AI services.

User Interacting Device: A device capable of interacting with user such as to receive, process, and present output responsive to a user's input, the input comprising text input, audio input, image input, video input, and input in any digital format. User interacting devices may be devices capable of performing limited AI services, such as wearable devices (smartwatches, smart rings, glasses, hearing aids, earbuds, headphones, etc.), home devices (speakers, security cameras, televisions, projection screen monitors, etc.), CarPlay devices, or any other devices with limited AI capabilities (webcams, sound bars, etc.), or devices capable of performing more robust AI services, such as smartphones, tablets, personal computers, laptop devices, etc. The more robust AI services comprise the limited AI services (such as a smartphone also having the capabilities of a smartwatch).

Smart enabled audio hardware (“smart audio device”): User interacting devices comprising sound or audio-related hardware (such as microphone and speaker) and a smart audio virtual assistant. The smart audio virtual assistant has AI capabilities to facilitate audio-related user interaction. Audio-related user interaction may comprise accepting, processing, and presenting output responsive to a user's audio input, touch input, or passive interaction (such as, but not limited to, passively monitoring for user input through monitoring user placement, emotion expression, movement, hand gestures, facial features, and other body language). The mechanical arm system (MAS) and the smart audio virtual assistant can access each other via electronic connection such as wired or wireless, and any communication standard such as Bluetooth, networks, optic communication, Wi-Fi, nearfield communication, cellular networks, or any wired protocol.

Smart enabled video hardware (“smart video device”): User interacting devices comprising image or video-related hardware (such as camera and video display screen) on a smart video virtual assistant. The smart video virtual assistant has AI capability to facilitate video-related user interaction. The video-related user interaction may comprise accepting, processing, and presenting output responsive to a user's visual or video input. The MAS and the smart audio virtual assistant can access each other via electronic connection.

Domain: The category that is being used by the user on the device. For example, a domain could be streaming, allowing a user to watch a television show via the video player screen.

AI application model: AI application model refers to the artificially intelligent algorithm in the smart audio virtual assistant and the smart video virtual assistant to facilitate direct communication between the user, the smart audio device, the smart video device, and the MAS. A model is an algorithm utilizing one or more functions to accomplish one or more tasks. The AI application model may be software stored in memory such that the software executes on a processor and may comprise audio processing models such as automatic speech recognition (“ASR”) models and natural language understanding (“NLU”) models, and video processing models such as, but not limited to, emotion detection, gesture recognition, body tracking, hand tracking, key point monitoring, and gaze tracking. For example, if a user says, “please have the screen face me”, the smart audio AI application model may utilize user audio processing to convert the audio command (“please have the screen face me”) into a text command that the MAS can perform. Then the smart video AI application model may utilize user video processing to process video input from the user. For example, the camera of the user interacting device may use the facial detection model to locate the user's face. This location may be sent as a command that the MAS will use to rotate the screen toward the user.

Device audio feedback: The audio response from the user interacting device to the user acknowledging the user's request. For example, in response to a user command “please have the screen face me”, the user interacting device may say “Got it. I will rotate the screen, so it faces you.”

Device video feedback: The video screen displaying or using a facial recognition model (software executing on a processor) to locate and/or identify the user's face. This could be represented by a green circle that surrounds the user's face. This is a way for the device to communicate that the request was heard and is processing.

On-device domain: A category or activity a user performs through a user interacting device, such as watching a cooking recipe video or a virtual classroom lecture. The user's viewing experience is limited to the range of motion of the video streaming device that is being used by the “teacher” or video presented. A teacher is defined as the user who is presenting the information.

Mechanical Arm System (“MAS”): An AI device comprising a mechanical system with rotational abilities on one or more axis used in conjunction with a smart audio device and/or a smart video device such as a user interacting device. The MAS may rotate on the X axis, such as in one embodiment, 360 degrees. The MAS may also rotate on the Y axis or the Z axis. The MAS may or may not include and arm such that the MAS may comprise an arm movable in one or more axis of rotation or movement of the MAS may be a slot or cradle for the user interacting device, or a permanent (integral) connection to a user interacting device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

The MAS may interact with the user through audio and visual cues. The smart audio device and/or the smart video device may facilitate this communication through their respective AI application models. The AI application models may process all user audio and/or video input to, and all audio and/or input from, the smart audio device and/or smart video device.

In one example method of operation, a user may say “move the screen to the right” to a user interacting device, which may be a smart audio device or a smart video device. As mentioned above, the smart video device may comprise smart audio hardware (such as speaker and microphone) and a smart audio AI application module. The smart audio AI application model may receive and process the audio input, such as by using a natural language understanding model (described below) to generate a digital data representation of the audio input and to create an audio service request using the digital data representation.

The smart audio AI application model may pass the audio service request to the user interacting device and the MAS or directly to the MAS. A service request is an action command, prompting a software to execute a function or group of function responsive to the action command so as to fulfill the service request. In this example, the smart audio AI application module may use the audio service request to cause the user interacting device to confirm user input by outputting the audio feedback “okay, will turn screen to the right” using the speaker of the user interacting device. The smart video AI application module may simultaneously or subsequently execute the audio service request by: (1) using a video hardware command to cause a camera of the user interfacing user interacting device to locate the user's face or body to provide exact rotation degree movement to the arm, and (2) using a movement command to cause the user interacting device to rotate so the screen of the user interfacing device is moved to the right, such that it is facing the user on the right. There may be real time feedback between the camera and the software to achieve the correct amount of rotation. This processing can be done directly on the user interacting device comprising the smart audio AI application module and/or the smart video AI application module or using functionality built into the MAS. Communication between the arm and the computing may occur using any means such as wired or wireless and any communication standard may be used such as Bluetooth, WIFI, nearfield communication, or any wired protocol.

The MAS may be in communication with or connected to the user interacting device, such as a smart audio AI application module and/or a smart video AI application module. In one embodiment, the connection comprises a wired connection that connects the user interacting device to the MAS such that the MAS may access the audio and/or video hardware in the user interacting device. In one embodiment, the MAS may have its own smart audio device. In one embodiment, the base of the MAS may include the smart audio hardware and the smart audio AI application module. In one embodiment, the MAS does not comprise a built-in smart audio device. In this embodiment, the MAS may use the hardware and/or software on the user interfacing device to which the MAS is connected, such as the audio and video hardware.

The user input may pass through one or more input processing model (such as an ASR and/or an NLU model to process audio input). The input processing models may be provided by the smart audio AI application model and/or smart video AI application model in the user interacting device or in the MAS. The input processing models may convert the user input into service requests. For example, an audio processing model may turn a user's audio input into an audio file, which is then processed into the output of a text file with a service request.

There are two types of audio cues that may be used by the AI application model: user audio cue and device audio cue. A user audio cue is defined as the spoken words from a user. For example, the user might say “turn the screen to my left” as an action command based on the user needing to see the screen at a different angle. Device audio cue is defined as the spoken words from a smart audio device. For example, the user interacting device might say to a user “would you like me to rotate the screen so you can see better?” as the user interacting device comprising a smart audio AI application module detects the user move to the other side of the room or shifted to one side or the other.

There are numerous types of visual cues that may be used by the AI application module. Two exemplary types of visual cues that may be used by the AI application model include user generated video and device generated video. User generated video is the real-time stream of a user who is using the user interacting device. Device generated video is the video stream that correlates to the domain being used, i.e., video being shown on the user device. This video stream can either be a programmable video that correlates to a domain or a live-stream video. An example of programmable videos would be a television show or movie. An example of a live-stream video would be a video chat.

In the embodiment described herein, the MAS has the ability to interact with the user in the following ways: (1) imitation, (2) user video detection, (3) user audio detection, and (4) multi-user tracking.

Imitation refers to the MAS's ability to imitate or react to what the user's movement or gestures. For example, if a user was watching a movie on the user interacting device with a race car scene, the user may imitate or react to the motion of the car as it goes around turns. The MAS may, in turn, tilt or rotate the video display device on the user interacting device to imitate the user's motion. This imitation is achieved by the AI application model on the smart video device causing the camera on the user interacting device to detect the user's motion, processing the user's motion to generate a service request to the MAS, causing the MAS to fulfill the service request by performing a desired movement. In another example, if the user tilts their head to the side, the screen may also be tilted to the side to thereby maintain ideal eye alignment with the screen.

Imitation may involve training of the AI application model. A model may be “trained” with a set of data, for instance audio files for word detection and then updated over time as part of the training process to improve the model. AI a model may replicate a decision process to enable automation and understanding of a user request. AI and machine learning models are algorithms that use user input, device input, and prior data along to achieve training using data and human expert input to replicate a decision an expert or user would make when provided that same information. In the use case described above, the AI application model may be trained on streaming movies and television shows. The training data may comprise both videos of users watching movies and imitating the scenes shown on the screen as well as the actual scene from the movie or show.

The second way of user interaction is user video detection, which refers to the MAS's ability to detect a user's motion in real-time. Motion detection may be enabled with software configured to correctly tag, track, and follow a user. The term tag refers to the ability of the software to identify a user's face, arms, neck, chest, and other body parts. The term track refers to the ability of the software to remember the tagged body parts. The term follow refers to the ability of the software to use the tracking to follow the movement in real-time. In the case of imitation, a user may use audio cues to command the mechanical arm to perform tasks or change the imitation status of the system. For example, a user could say “stop imitating my movement” and the MAS would process the audio through the NLU model to execute the command. The user could also say “track my hand and not may face” and the MAS would track the user's hand.

Motion detection is useful for the video display device on the user interacting device connected to the MAS to always face the direction of the user. This allows the user to have the screen face the user so the user can best see the video screen at all times (such as when moving about an area, cooking, during a video chat or presentation, or to follow a family member). The AI application model may comprise a video detection alignment processing for following user movement. The AI application model may also be trained for motion detection. The optimal viewing experience for a user may be a screen angle that aligns the user's pupils or face directly into the center of the video display device of the user interacting device.

The third way of user interaction is user audio detection, which refers to audio spoken by the user as audio commands that tell the user interacting device what to do. For example, a user could say “turn the screen to the left” and the screen would turn slightly to the left. Below is a snippet of exemplary commands that can be executed, although other commands are possible and contemplated:

“Turn the screen to the left”

“Turn the screen to the right”

“Follow my movement”

“Stop following me”

“Tilt the screen up”

“Tilt the screen down”

“Put the screen at a 180 degree angle”

“Have the screen lie parallel to the ground”

“Have the screen rotate back and forth to the left and the right at a steady pace”

“Have the screen track my face for movement”

“Have the screen track my chest for movement”

“Tilt the right side of the screen towards the ground”

“Tilt the left side of the screen towards the sky”

“Have the screen rotate 360 degrees”

The combination of audio cues and video cues with a full-range of motion MAS greatly improves user experience. Users no longer have to move or adjust the user interacting device for an optimal experience because the AI application models control the MAS to move the user interacting device for the user to a directed or optimal position.

The fourth way of user interaction is multi-user tracking, which refers to the MAS's ability to track two or more users at one time. The user video detection has the ability to tag, track, and follow multiple users at one time. For example, if there are two users, but only one is moving, the MAS may follow the movement of the user on the move. Users have the ability to combine the multi-user tracking with audio cues. For example, a user may say “follow John instead” and the arm would now track John's movements.

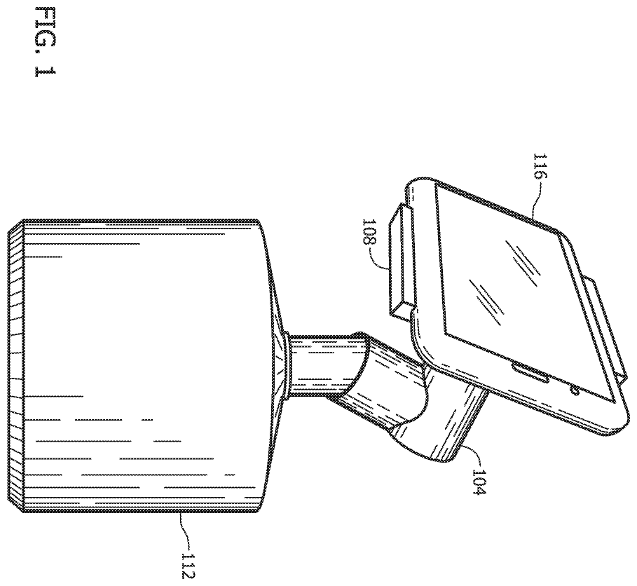

FIG. 1 illustrates the attachment mechanism of the MAS to a smart audio device (such as a smart speaker) and/or a smart video device (such as a smartphone with a screen). In the example embodiment of FIG. 1, the MAS 100 comprises a 3-joint articulating neck 104. The neck 104 is attached to a user device clasp 108 on one end, and a built-in smart speaker 112 on the other end. The user device clasp 108 is used to hold any user interfacing device 116 in place. If the user interfacing device 116 is a smart video device, then the clasp may allow the video output device of the user interfacing device 116 to face the user.

The joints on the neck 104 may permit movement on both the X- and Y-axis, and the connecting portion of the neck 104 to the smart speaker 113 may permit 360-degree circular rotation. In other embodiments, any other type mechanical arm arrangement may be utilized which is capable of functioning as described herein. For example, the arm may be replaced by a fixed clasp which holds the device in a stationary position which is able rotate in 360 degrees of rotation or enable movement along only two axis. In addition, instead of a clasp, the user device may rest in a slot or cradle.

In the example shown in FIG. 1, the smart audio device includes a smart speaker 112 comprising the hardware necessary to facilitate audio-related user interaction (such as a microphone to detect a user's audio input and a speaker to output sound) and a smart audio AI application model to process user interaction, as discussed above. In other embodiments, the MAS may use a weighted base which does not comprise a built-in smart speaker. The MAS may use the smart audio hardware and smart audio AI application module on the connected user interacting device 116 or on other devices the MAS may access remotely (discussed in greater detail below).

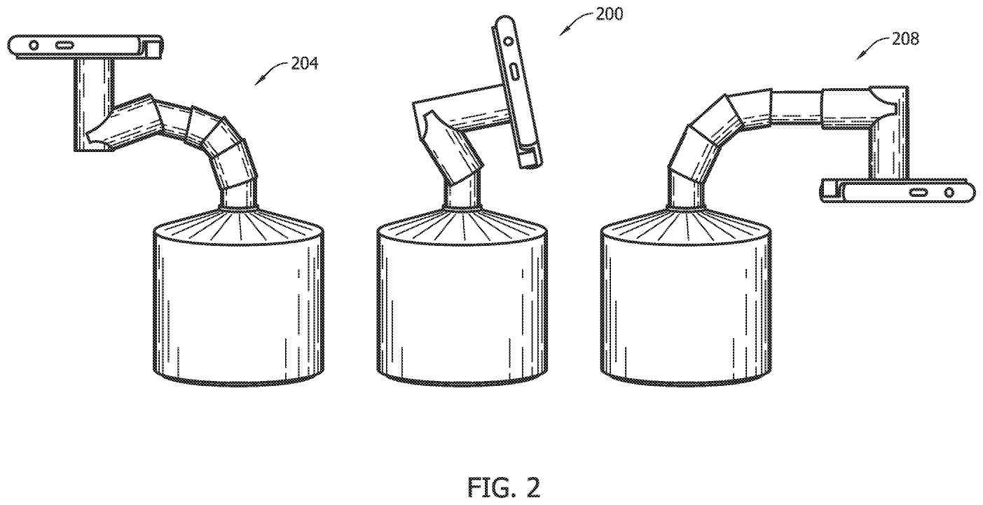

FIG. 2 illustrates the Y-axis movement of the MAS utilizing a range of motion of 180 degrees in an arch motion that allows the video player device to have the screen point up or down. In other embodiments, angular movement other than 180 degrees may be enabled. In its default position 200, the MAS allows the video display device of a user interacting device (such as the screen on a smartphone) to face the user. Position 204 illustrates the video display device facing upwards at a 90-degree angle from a starting position. This position may be useful for users who are standing and looking down or if playing game alone or with another person. Position 208 illustrates the video display device facing downwards at a 90-degree angle from a starting position. This position may be useful for users who wish to use the user interacting device to scan a document or video something on a table. This allows the screen to be visible at a variety of different angles. In one embodiment, the Y-axis movement may be of any degree ranging from 0 to 360.

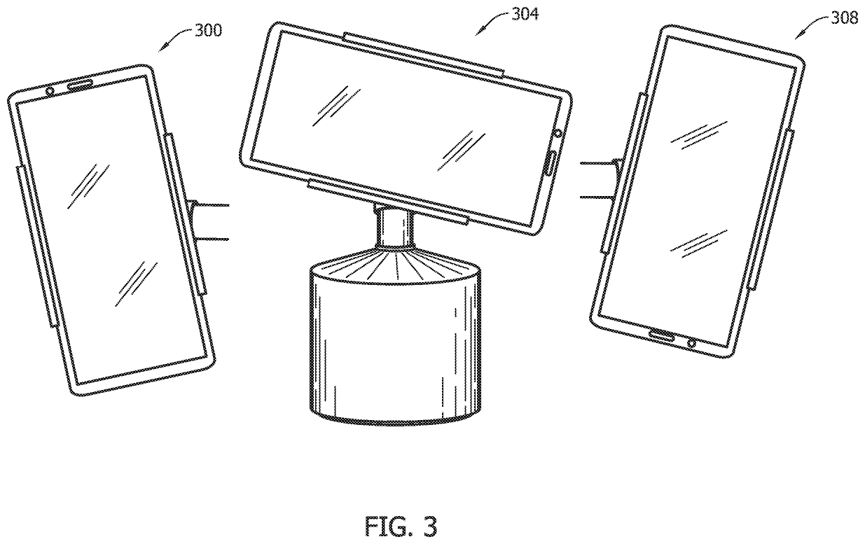

FIG. 3 illustrates the X-axis movement of the MAS utilizing a range of motion of 180 degrees in an arch motion. In other embodiments other than 180 degree motion range may be provided. The arch motion ranges from the video display device being placed vertically on one side of the MAS (as shown in position 300), to the video display device being placed on top of the MAS (as shown in position 304), to the video display device being placed vertically on the other side of the MAS (as shown in position 308). This enables the video player screen to tilt at an angle that best faces or matches the user. For example, a 180-degree angle vertical alignment 300, 308 may be optimal for a specific user experience, while a horizontal alignment 304 may be optimal for a different user or use. This function may also be useful when a user moves their body or head side-to-side to align the video display device with a user, such as generally aligned with the user's eyes. This means a user's eye alignment may be at a different angle. The MAS may react to the user's new posture position and shows the user the video player screen in a position that represents the user's current version of center of gravity or eye alignment. The mechanical arm (KaiBot) disclosed herein allows for this range of motion and freedom. In one embodiment, the range for the arch motion may be of any degree ranging from 0 to 360.

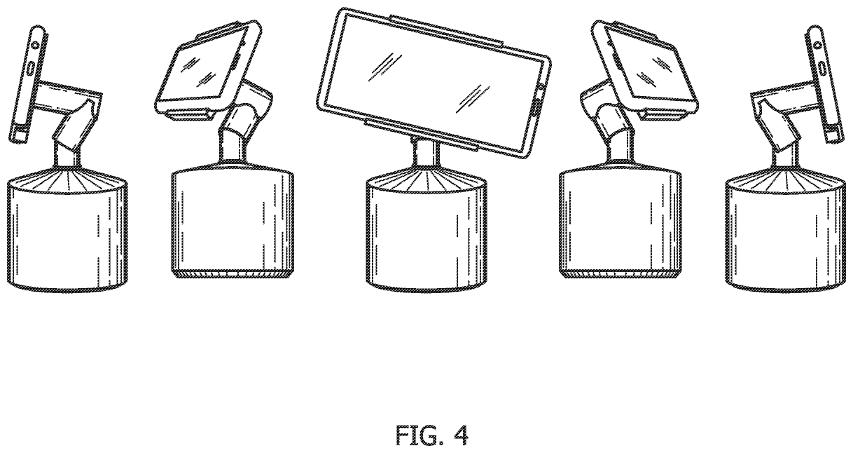

FIG. 4 illustrates the range of motion for MAS the mechanical arm on the X-axis. In this embodiment, the X-axis can move or rotate 360 degrees around the base of the neck. Rotation may occur in any manner such as by rotating the arm, the base, or a combination of both. The X-axis movement allows for a user to use audio cues to command the MAS to tell the device “rotate the connected user interacting device “in a circle” or to a particular position or for user tracking. The X-Aaxis movement aligns and displays an optimized viewing experience allowing the MAS to point or direct the video display device (such as the screen on a smartphone) based on where the user is located in relation to the video display device. In one embodiment, the range for the X-axis motion may be of any degree ranging from 0 to 360.

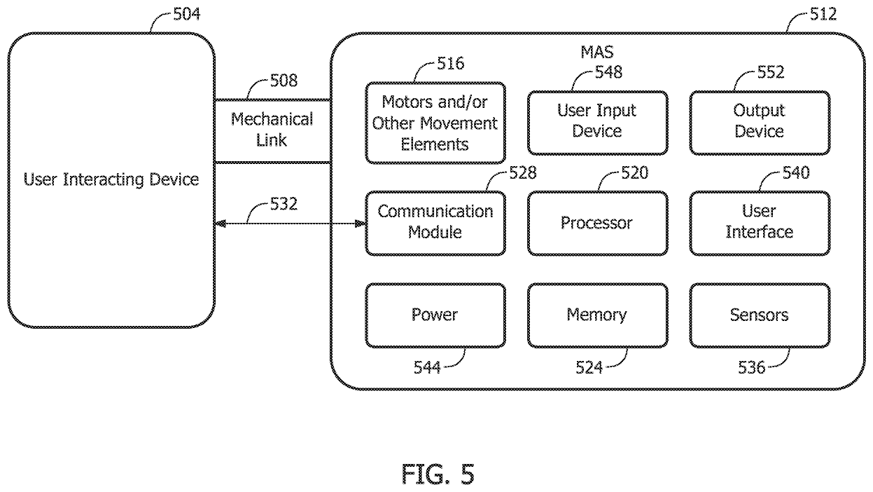

FIG. 5 illustrates a block diagram of the components of one example embodiment of the MAS. In other embodiments, other configurations and elements are possible. A user interacting device 504 may be linked to an MAS 512 by a mechanical link 508 which may be part of the MAS 512. The mechanical link may be any type mechanical link such as a clasp, cradle, tray, or permanent connection (plastic) connecting the screen to the base such as to form a unified device. As described herein the user interacting device 504 may be a smartphone, tablet, smart screen, screen, or any other user interacting device which may be mounted to the mechanical link 508 or which is permanently fixed to the base.

In this embodiment, the MAS 512 may include one or more motors and other movement elements which control movement and rotation of the mechanical link 508 or movement of the MAS itself. Overseeing operation of the MAS 512 may be a processor 520 configured to execute machine executable instructions or otherwise oversee and control operation of the MAS. The processor 520 communicates with a memory 524. The memory 524 may be any type memory capable of storing data and/or machine executable instructions. The memory 524 may store or be configured with machine readable code (software) configured for execution on the processor 520. Also included in this embodiment is a communication module configured to communicate with the user interacting device 504 and/or over a network, such as a local area network or the Internet to access remotely located computers or servers. Any type communication may be utilized by the communication module including wired or wireless links.

One or more sensors 536 may be part of this embodiment to provide input to the MAS 512. The sensors 536 may include but are not limited to a camera, microphone, vibration sensor, accelerometer, light detector, thermometer, or any other type sensor. A user interface 540 may include one or more buttons, switches, touch screen, display, trackball, lever, or wheel, to allow a user to provide input to the mechanical arm system 502. A power source 544 may also be included and configured to provide power to the various elements of the MAS 502. The power source 544 may obtain power from batteries, solar, or a wired connection.

In one embodiment, the MAS 512 may also include a built-in user input device 548 and an output device 552. For example, the MAS may have a built-in smart audio device, which may include a user input device 548 in the form of a microphone, and an output device 548 in the form of a speaker. The MAS may also include one or more cameras.

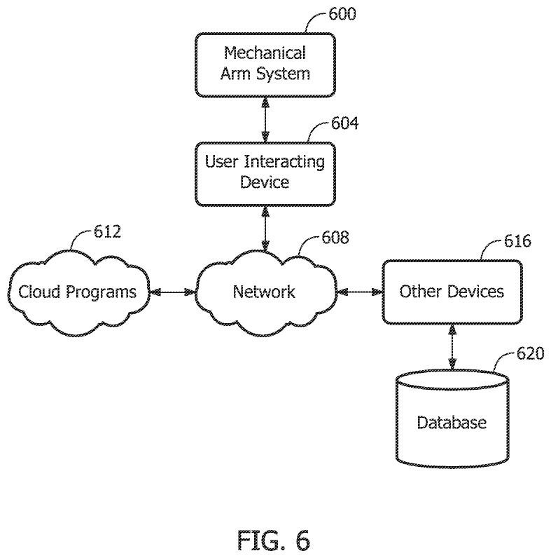

FIG. 6 illustrates an example environment of the use of the MAS. This is but one possible environment of use and system. It is contemplated that, after reading the specifications provided below in connection with the figures, one of ordinary skill in the art may arrive at different environments of use and configurations. In FIG. 6, a MAS 600 is attached to or configured with a user interacting device 604, which has access to a communication network 608. The network 608 may be a Wide Area Network (WAN), a Local Area Network (LAN), a Personal Area Network (PAN), a Wi-Fi network, a Bluetooth network, a cloud network, or any type of network comprised of one or more communication connections. The network 608 may also be accessible to cloud programs 612 and/or other devices 616. Cloud programs 612 may comprise any operating system, user interfacing application, database, or any other non-transitory machine executable code stored in a cloud or a remote cloud-based server. The other devices 616 may, in turn, be connected to device-specific databases 620. The user interacting applications installed on the other devices 616 may also be connected to their application-specific databases.

As discussed above, the user interacting device 604 facilitates the MAS's 600 interaction with users. The user interacting device 604, in turn, may access and use resources from cloud programs (software, hardware, or both) 612 and other devices 616 on the network 608 to further facilitate that interaction. For example, the MAS 600 may be an embodiment with no built-in smart audio AI application module, while the user interacting device 604 may be a device with limited AI capabilities (such as a smartwatch with no audio processing modules). Thus, a user's audio input (such as voice command) to the MAS 600 or to the user interacting device 604 may be routed through the network 608 to an audio processing module on a cloud program 612 (such as a cloud-based ASR module) or to another device 616 (such as a smartphone with speech recognition capabilities).

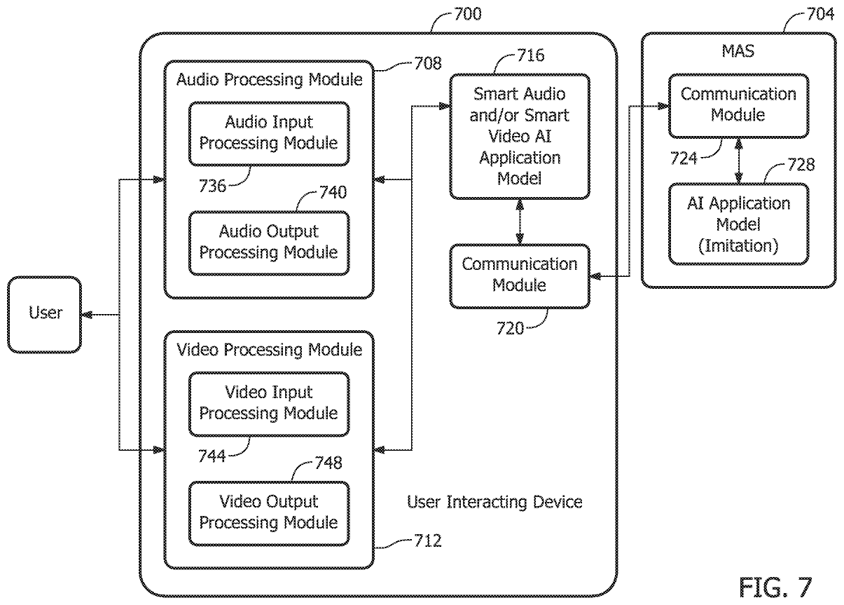

FIG. 7 illustrates an example software module layout of the MAS and its attached user interacting device. This is but one possible layout and it is contemplated that, after reading the specifications provided below in connection with the figures, one of ordinary skill in the art may arrive at different software module layouts.

In FIG. 7, a user interacting device 700 is attached to a MAS 704. The user interacting device 700 comprises an audio processing module 708 to process audio input and output, a video processing module 712 to process video input and output, a device AI application model 716 to facilitate user interaction with the MAS 704, and a first communication module 720 to facilitate communication between the user interacting device 700 and the MAS 704. The MAS comprises a second communication module 724 and a MAS AI application model 728.

In FIG. 7, the user interacting device 700 has robust AI capabilities (such as a smartphone or tablet). Thus, the device AI application model 716 may be a smart video AI application model and may facilitate user interaction with the MAS in both audio format and video format. As discussed above, the user interacting device 700 may also be a device with limited AI capabilities (such as a smartwatch), and its device AI application model 716 may be a smart audio AI application model, which may facilitate user interaction with the MAS 704 in audio format only. It is contemplated that the user interacting device 700 (such as a tablet computing device) may be configured with the MAS 704 as a single unit or the user interacting device may be removable from the MAS.

The first and second communication modules 720, 724 are used to send information from the user interacting device 700 to the MAS 704 and vice versa. In one embodiment, the communication modules 720, 724 may be built into the AI application model (such as the device AI application model 716 configured to include the first communication module 720, and the MAS AI application model 728 configured to include the second communication module 724).

The user interaction with the MAS 704 begins when a user 732 initiates interaction via user input. For example, an audio input device (such as microphone) on the user interacting device 700 may receive a user's 732 audio command. If the user input only requires audio processing (such as an audio command “move my phone to the left”), then the user input is sent to the audio processing module 708. The audio processing module uses its audio input processing module 736 to convert the user input into a service request, which is then routed from the device AI application model 716 to the MAS AI application model 728 through the first and second communication modules 720, 724. The MAS AI application model 728 may cause the MAS 704 to execute the service request and to output the desired user response (such as causing the attached user interacting device 700—in this example the user's phone—to move left). The device AI application 716 may also cause the audio output processing module 740 to generate a device audio feedback (such as the user interacting device 700 outputting the voice response “ok, moving to the left”).

If the user input is a request that requires both audio and video processing (such as an audio command “follow me”), in addition to interacting with the audio portion of the user input, as described above, the MAS may also interact with the user's video input (such as movement). A video input device (such as a camera) on the user interacting device 700 may detect and capture the user's video input (such as movement). The video processing module 712 may use its video input processing module 744 to process the captured video input (such as a video recording) into a service request (such as to imitate the movement). The service request may be routed from the device AI application model 716 to the MAS AI application model 728 through the first and second communication modules 720, 724. The MAS AI application model 728 may cause the MAS 704 to execute the service request and -perform or output the desired user response (such as to imitate the user's movement or any other function). The device AI application 716 may also cause video output processing module 748 to generate a device video feedback (such as the user interacting device 700 outputting a display of the captured video of the user, and an indicator showing the user's center of mass, the indicator moving as the user moves).

In FIG. 7, the MAS 704 does not comprise a built-in smart audio device (such as illustrated in FIG. 1), or a built-in smart video device. Thus, the MAS AI application model 728 may only have the capability of responding to service requests to output the desired user response (such as imitation of a user's movement or gesture, or effect a movement). In other embodiments, the MAS 704 may include a built-in smart audio device (such as illustrated in FIG. 1). In that embodiment, the MAS AI application model 728 may be capable of processing the user's audio input using its own smart audio device. In one embodiment, the MAS 704 comprises a built-in smart video device that is configured to be a single unit. In that embodiment, the MAS AI application model 728 may be capable of processing the user's audio and video input using its own smart video device.

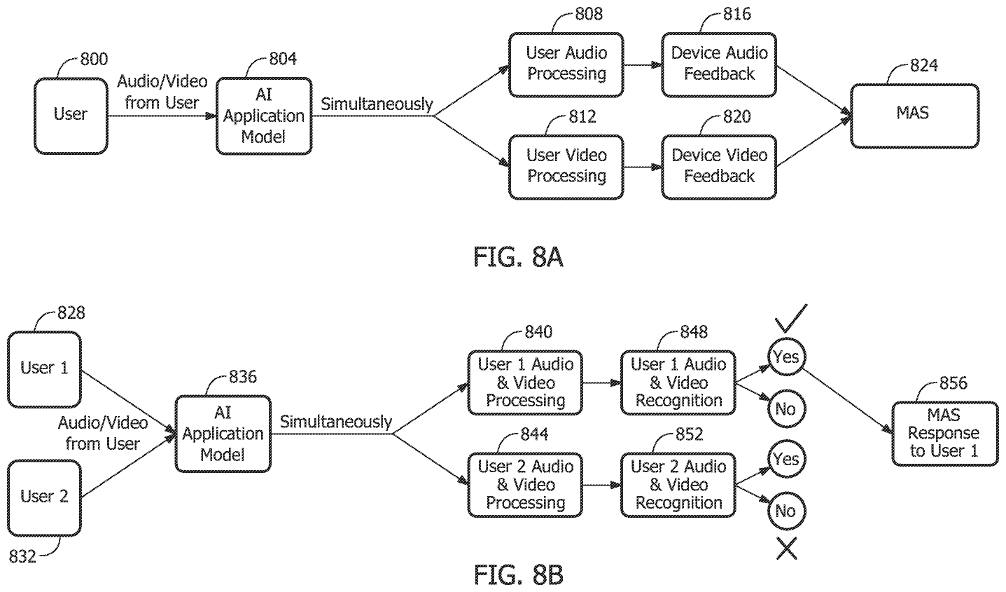

FIG. 8A illustrates the MAS's single-user interaction capabilities using the example of a smart video device. Though not illustrated, the MAS may also perform single-user interactions using smart audio devices, where user input may be limited to audio-related input (such as voice commands), and user input processing may be limited to audio processing. The smart audio device may comprise a user interacting device (permanently or removable attached to the MAS), or the smart audio device may be integrated within the MAS.

In FIG. 8A, a single-user interaction begins when the user 800 initiates the interaction. The user input then travels through the AI application model 804, which simultaneously processes the user's audio input 808 and video input 812. The interaction is returned via output of one or more user responses, which may comprise device audio feedbacks 816, device video feedbacks 820, and/or MAS responses 824.

Using a previous example, the user 800 may say to the MAS “follow me.” The AI application model 804 may process the audio input (such as the user's voice command) 808 into a service request that the MAS 824 perform a movement, and a service request that the user interacting device output the device audio feedback 816 “ok, following you.” Simultaneously, the AI application model 804 may cause the user interacting device to generate a video input of the user 800 by detecting and capturing the user's 800 movement in the form of a video file. The video file may then be processed 812 into a service request that movement the MAS 824 must perform is imitation (tracking) of the user's 800 movement, and a service request that the user interacting device output the device video feedback 820 of a display of the video file and an indicator that the MAS is tracking and imitating the user's movement causing the MAS to move the user device

FIG. 8B illustrates the MAS's multi-user interaction capabilities using the example of two users interacting with a smart video device. Though not illustrated, the MAS may also perform multi-user interactions using smart audio devices and may interact with any number of users. In one embodiment, the maximum number of users may be specified based on developer choices, user preferences, or limitation of resources such as device capabilities, device battery power, or usable mobile data.

In FIG. 8B, a multi-user interaction begins when either the first user 828 or the second user 832 initiates the interaction. Depending on the user request, one or both users' 828, 832 inputs travels through the AI application model 836, which simultaneously processes one or both users' audio and video inputs 840, 844 and generate a service request (such as imitate, track or otherwise interact with, one user's movement). The AI application model may perform additional audio and/or video processing to recognize additional user input 848, 852, which may be necessary to execute the service request (such as determining which of the two users 828, 832 to imitate). Upon successfully recognizing (such as determining the first user 828 as the user to imitate) and processing (such as capturing the first user's 828 movement) the additional user input, the AI application model may then generate a complete service request and cause the MAS to output the desired response 856 (such as imitating or tracking the first user's 828 movement and not the second user). Though not illustrated in FIG. 8B, the AI application model generate additional service requests for device audio feedback and/or device video feedback instead of, or in addition to, the MAS output 856.

For example, the first and second user 828, 832 may both be in the frame of video on the video screen of the user interacting device held by the MAS. This use case may occur when a first user 828 is playing a video game and the second user 832 is watching the screen or the first user 828.

It may be initially unknown to the AI application model 836 that this user may be the first (primary) user 828 until the primary user says “follow my movements” as they are playing the game. The AI application model 836 may process the audio command to generate a service request that the MAS perform a movement to imitate (track) a primary user to keep the screen facing the primary user.

Through image or video capture and processing (image processing may be performed by or part of the video processing module) 840, 844, the AI application model 836 may recognize two users in the video file. The AI application model 836 may then perform the audio and video recognition for both users simultaneously 848, 852 since the AI application model 836 does not know which user spoke the voice command or initiated the request.

Upon performing audio and video recognition on the first user 848, the AI application model 836 may determine the first user 828 is currently moving back and forth as the user is playing the game and/or that the first user's 828 mouth was moving while the audio speech was being detected for “follow my movements.” Either or both determinations may indicate the first user 828 should be followed.

Simultaneously, the AI application model 836 may perform audio and video recognition on the second user 852 to determine the second user 832 has not moved his body, and/or has not moved his mouth while the audio speech was being detected. Either or both determinations may indicate the second user 852 should not be followed. Though not illustrated in FIG. 8B, the AI application model may receive confusing or conflicting indications, and may, using a first round of recognition, still be unable to determine which user to follow. The AI application model may perform multiple iterations of recognition or continuing recognition (such as to detect whether there is on-going movement by one user) for clarification. The AI application model may also prompt an audio output to ask for clarification (such as “two users detected, please indicate which user to follow”).

Upon identifying the first user 828 as the user to following, the AI application model 836 may generate a service request to the MAS to follow the first user 856.

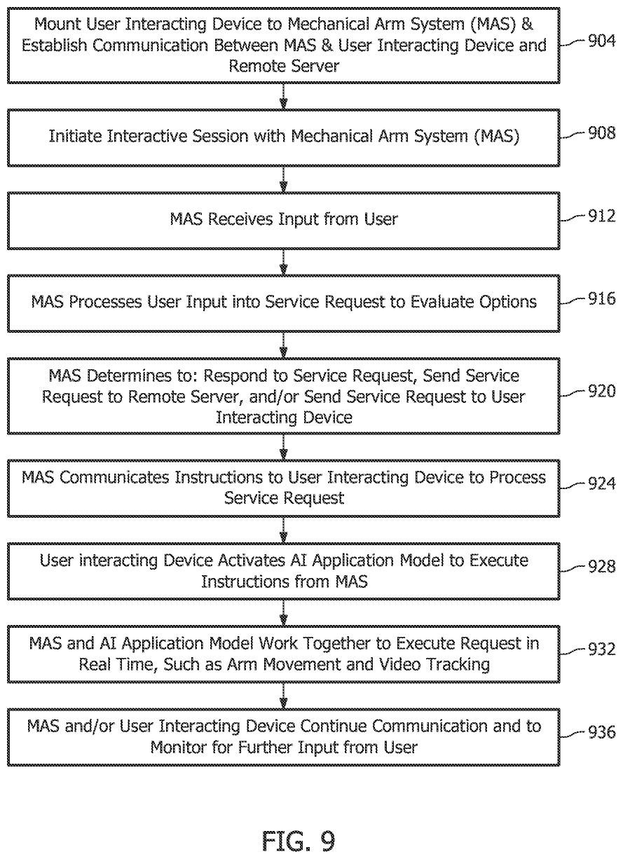

FIG. 9 illustrates a flow diagram of an example method of use of the MAS. The flow diagram of FIG. 9 illustrates communication between the user, the MAS, and other elements (such as an attached user interfacing device and/or other devices or cloud programs or servers), where the smart audio device is built into the MAS. Other methods of operation and operations which branch from this this exemplary method operation are possible and contemplated. For example, in an embodiment discussed above, the MAS may not have a built-in smart audio device and may use the audio-related hardware and smart audio AI application model of the attached user device instead (such as the microphone and audio processing modules on a smartphone attached to the MAS). In another embodiment, the MAS may have both a built-in smart audio device and a built-in smart video device, and both built-in devices work in conjunction with the attached user interacting device to receive and process communication. In yet another embodiment, the MAS and the user device are integrated into a single, self-contained unit.

In a step 904, a user interacting device (such as a smartphone) is mounted to the MAS (or is already mounted/permanently mounted). Communication between the user interacting device and the MAS is established. Communication may occur by one or more of Bluetooth, WiFi, NFC or a wired connection. In another embodiment, the user interacting device may already be permanently attached/connected to the MAS. The user interacting device and the MAS may also establish communication to other devices, remote servers, software, or hardware stored in a cloud or cloud-based servers. For example, while an iPhone is mounted to the MAS, the iPhone and/or the MAS may also be in communication with smart speakers and a smart TV in the same room, or the iPhone user's Apple account information stored in a cloud.

In a step 908, upon establishing communication between the user interacting device and the MAS, an interactive session may be initiated. In one embodiment, the interactive session may be initiated automatically. In another embodiment, the interactive session may be initiated by user command. During the interactive session, the built-in smart audio device on the MAS monitors for user input. In one embodiment, any input device on the MAS, the user interacting device, and any other devices or in the cloud may be used to monitor for user input.

In a step 912, the MAS may receive input from the user (such as voice command for speech recognition). In embodiments where more than one input device monitors for user input, such as other input devices may also receive input from the user. In a step 916, the smart audio AI application model in the MAS built-in smart audio device may process the audio input to evaluate options. Such processing may involve using an audio processing module to transcribe the audio file of a voice command into a service request. In one embodiment, any input device on the MAS, the user interacting device, and any other devices or in the cloud may receive user input, and any AI application model on any device may be used to process the received user input.

In a step 920, the MAS determines how to best fulfill the service request. If the MAS can fulfill the service request locally (using resources in the MAS), it may do so. If the MAS requires additional information or capabilities from remote servers or from the user interacting device, it may offload the service request to the remote servers or the user interacting device. Offloading means routing an unfulfilled service request to another device and/or application to fulfill. For example, a simple voice command of “move left” may prompt the MAS to respond by moving its mechanical art to the left. A more complex voice command of “scan this page and find me the book this page is from” may prompt the MAS to (1) cause the smartphone attached to the MAS to move into a face-down position so the camera on the smartphone may scan the page or bar code, (2) cause the scanned image to be sent to a search engine in a remote server to find a book, and (3) cause a PDF version of the identified book to be sent to the smartphone to display to the user or provide ordering information to purchase the book (or any item).

In a step 924, the MAS may communicate instructions to the user interacting device to process the service request. In a step 928, the AI Application model in the user interacting device may execute the instructions from the MAS. Even a simple voice command, which the MAS may be capable of executing without the user interacting device (such as “move left”), may still cause the MAS to communicate instructions to the user interacting device to provide device audio feedback (such as “ok, moving left”). As previously discussed, the AI application model facilitates communication between the MAS and the user application device. Using the simple voice command “move left” as an example, the MAS may send a simple instruction for a device audio feedback to the AI application module. The AI application module then communicates with the user interacting device's audio output module to prepare and output the audio feedback “ok, moving left” or a question back to the user, such as “is this far enough?”.

When, as specified in step 904, the MAS and/or the user interacting device established communication with other devices and/or remote servers, the AI application model may run on and/or interfacing across multiple devices. For example, a voice command to “show me a movie but play the sound on my smart speakers” may cause the AI application to output the movie on the display device of the user interacting device and simultaneously output the audio file of the movie through the smart speakers. A single AI application model (such as an AI application model in the user interacting device) may prompt both output, or the two outputs may be coordinated using multiple AI application models (such as a first AI application model in the MAS, a second AI application model in the user interacting device, and a third AI application model in the smart speaker).

A more complex voice command may cause the MAS to communicate instructions to the user interacting device to fulfill additional service requests. In a step 932, the MAS and the user interacting device may, through one or more AI application models, work together to execute a service request in real time. For example, a user request “follow me” may require the user interacting device AI application model to activate the user interacting device's camera to record and process the user's motion. The AI application model may then use motion detection and motion tracking modules to identify the user's motion and communicate that motion to the MAS. The MAS AI application model may then cause its arm to imitate the user's motion. In one embodiment, the AI application model in the MAS may control the user interacting device, and the AI application model in the user interacting device may control the MAS to move the arm to follow the user. User tracking software is known by those of ordinary skill in the art and as such not described in detail. Such software is available from Vision4CE.com. In one embodiment, a single AI application model (such as stored in the MAS, the user interacting device, any other devices, or the cloud) may control the MAS, the user interacting devices, and all other devices.

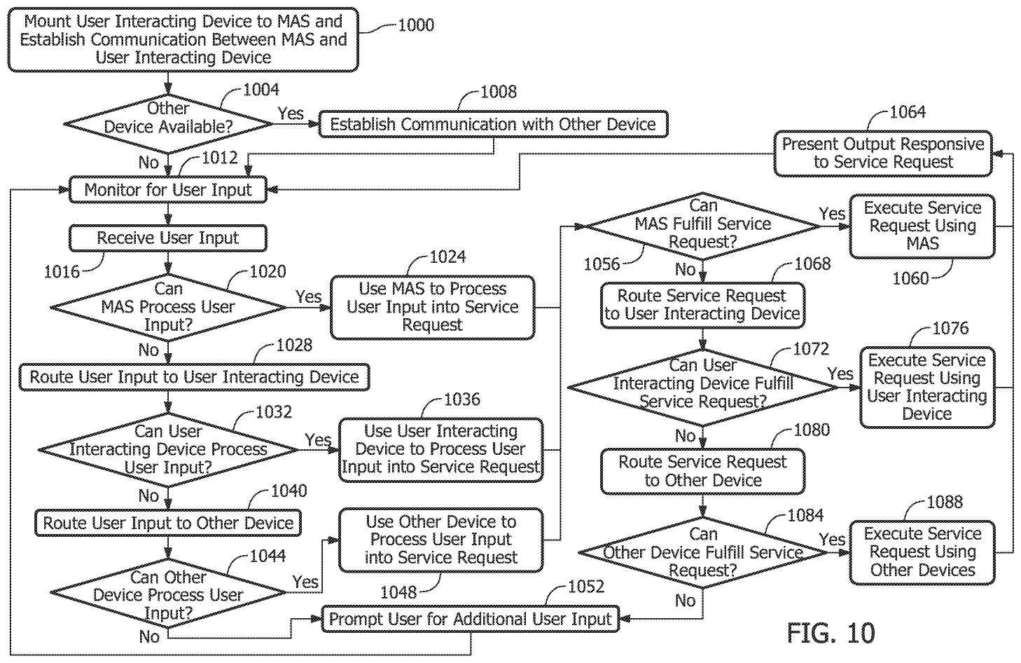

FIG. 10 illustrates a flow diagram showing communication between a MAS, an attached user interacting device, and other devices or cloud programs or servers, such that user request processing and service request fulfillment may both be offloaded from one device to another. Other methods of operation and operations which branch from this this exemplary method operation are possible and contemplated.

In a step 1000, a user interacting device (such as a smartphone) is mounted to the MAS or it may be an integral connected part to the MAS. Communication between the user interacting device and the MAS is established. Communication may occur by one or more of Bluetooth, WIFI, NFC or a wired connection. In another embodiment, the user interacting device may already be permanently attached to the MAS. In a step 1004, the MAS and/or the AI application model in the attached user interacting device may search for other devices to establish communications. Other devices may be other user interacting devices, remote servers, or software or hardware stored in a cloud or cloud-based server. For example, while an iPhone is mounted to the MAS, the smartphone and/or the MAS may also be in communication with smart speakers in the same room, or the iPhone user's Apple account information stored in a cloud. If other devices are found, in a step 1008, the MAS and/or the AI application model in the attached user interacting device may establish communication with such other devices.

Once communication between all devices and the MAS is established, in a step 1012 the MAS and/or the AI application model in the attached user interacting device may initiate an interactive session and monitor for user input.

Upon receiving user input in a step 1016, the MAS may first attempt to process the user input locally. In other words, the MAS may attempt to use its own built-in AI application model to process the user input. For example, if the user input is in the form of a voice command, the MAS may look for a speech recognition module in its own AI application model to convert the voice command into a service request. If the MAS determines it can process the user input locally, in a step 1024, the MAS may process the user input locally.

If the MAS is unable to process the user input locally (for example, where a MAS does not have its own AI application model or does not have a built-in speech recognition module), in a step 1028, the MAS may offload the user input to the attached user interacting device for processing. In a step 1032, the AI application model in the attached user interacting device may attempt to process the user input locally. In one embodiment, the MAS and the attached user interacting device may use a single AI application model, which may be in the MAS or the user interacting device. If the attached user interacting device can process the user input locally, in a step 1036, the user input is processed in the attached user interacting device. Using the example above, where the MAS does not have a built-in speech recognition module to process a voice command, the user input may be routed to the attached iPhone, which may attempt to use its speech recognition feature to process the voice command into a service request.

If the attached user interacting device is unable to process the user input locally, in a step 1040, the user input is offloaded to any other devices the MAS and/or the user interacting device established communication with. In a step 1044, one or more other devices may then determine if they may be able to process the user input locally. If the other devices can process the user input locally, in a step 1048, the other devices may process the user input into a service request.

In one embodiment, one or more AI application model in the MAS, the attached user interacting device, and the other devices may determine the optimal device to process the user input, rather than traversing the default steps of offloading the user input from the MAS to the attached user interacting device, then to the other devices. For example, upon receiving an audio command at step 1016, one or more AI application models may automatically determine a speech recognition module in a cloud may be best suited for processing the audio command, and the user input is directly routed to the cloud, as illustrated in step 1040, without proceeding through steps 1020 to 1032 first.

If, on the other hand, no device (the attached MAS, the attached user input device, and any other devices) can process the user request, then in a step 1052, the user may be prompted for clarification. For example, the user's original voice command may be in the form of incomprehensible speech or a vague command. The user may have input an audio command to “find Harry Potter” but the speech recognition feature recognized the phrase as “bind harri water”. The MAS or the attached user interacting device may then output a prompt to the user such as “did you mean ‘find Harry Potter’?” or “please repeat your command”. The MAS and all other devices may then return to step 1012 to monitor for another user input in response to the prompt.

If at any point the user input is successfully processed into an executable service request, in a step 1056, the service request may first be routed to the MAS to determine whether the MAS may fulfill the user input locally. If the MAS determines it may fulfill the service request locally, then in a step 1060 the MAS attempts to fulfill the service request locally. For example, the MAS may fulfill a service request for a simple voice command of “move my phone to the left” locally by commanding the mechanical arm to move left. The result of a fulfilled service request is, in a step 1064, an output to the user that is responsive to the user's input. In the example above, the responsive output may be the mechanical arm moving to the left.

If the MAS is unable to fulfill the user input locally (for example, if the voice command is to play an audio file, and the MAS does not have built-in speakers), in a step 1068, the service request may be offloaded to the attached user interacting device. In some cases, even when the MAS may fulfill a service request locally, it may still route additional service requests to the attached user interacting device. Using the example above, where the mechanical arm is commanded to move left, the MAS may also instruct the iPhone to output the device audio feedback “ok, moving to the left”. The responsive output in step 1064 may then be a combination of the mechanical arm moving to the left and the output of the device audio feedback.

Upon receiving an offloaded or additional service request, in a step 1072, the AI application model in the attached user interacting device may attempt to fulfill the service request locally. As discussed above, in one embodiment, AI application model may cause the user interacting device to attempt to fulfill the service request locally. If the attached user interacting device can fulfill the service request locally, in a step 1076, the service request is fulfilled in the attached user interacting device. For example, the voice command may be to play a video, and the MAS may not have a built-in video display device. The attached iPhone may then use its video display device. The responsive output in step 1064 is then the iPhone playing the requested video. The responsive output of step 1064 should be considered optional.

If the attached user interacting device is unable to fulfill the service request locally, in a step 1080, the service request is offloaded to any other devices the MAS and/or the user interacting device established communication with. In a step 1084, the AI application model in other devices may then determine if it is able to fulfill the user input locally. In one embodiment, any AI application model may cause the other devices to make that determination. If the other devices can fulfill the user input locally, in a step 1088, the other devices fulfill the service request. For example, the user input may be a voice command to “play the first Harry Potter movie on my smart TV”. While the attached iPhone may have the movie stored locally, it may route the movie file to a connected smart TV or stream it to the TV. The responsive output in step 1064 may be the display of the first Harry Potter movie on the smart TV.

In one embodiment, one or more AI application models in the MAS, the attached user interacting device, and the other devices determine the optimal device to fulfill the service request, rather than traversing the default steps of offloading the service request from the MAS to the attached user interacting device, then to the other devices. For example, upon receiving a service request to output a movie on a smart TV device at steps 1024, 4036, or 1048, one or more AI application model may automatically determine a connected smart TV may be most suitable for processing the audio command, and the service request is directly routed to the smart TV, as illustrated in step 1080, without proceeding through steps 1056 to 1072 first.

If, on the other hand, no device (the attached MAS, the attached user input device, and any other devices) can fulfill the service request, then the user may be prompted for clarification, as illustrated in step 1052. For example, where a user input was to “play the first Harry Potter movie on my smart TV” but no movie file was found, or no smart TV was connected, the MAS or the attached user interacting device may then output a prompt to the user such as “did you want to play the second Harry Potter movie?” or “no smart TV was found, play movie on iPhone instead?”.

Numerous various use example are possible beyond those disclosed above where the AI capabilities and voice interaction of the MAS provide numerous benefits. The movement tracking and control can be used to cause the MAS to track a user during many activities, such as playing music (focusing on user's hands), when exercising or doing stunts, live performances such as dance, sports activities (such as following a particular player during a basketball game, or team), following a user create or perform art, or any activity where an aspect of the user is to be tracked with a camera.

In addition, the MAS can be used to hold, support, or otherwise direct an item other than or in addition to a user computing device. For example, the MAS may hold and move a flashlight to light an area under a car or sink or any other location, such as to light an area for a user or provide a night light or light a walkway. The MAS can also hold and intelligently move a projector device to project an image on a wall or ceiling, such as for entertainment or video watching. The MAS with user interacting device can also be set up to be a securing monitoring system which can monitor for unexpected sound or motion. The MAX can automatically move the camera to create a video of the room or source of the sound and automatically upload that video or sound to a cloud or other user device.

In outside environment, the MAS may be pointed to the sky at night to track, view, or photograph, or video stars, planets, or constellations based on user input or through use of an associated application. It can also be used to create intelligent panoramic photographs or a yard, house, or an interior space with intelligent input and output from a user.

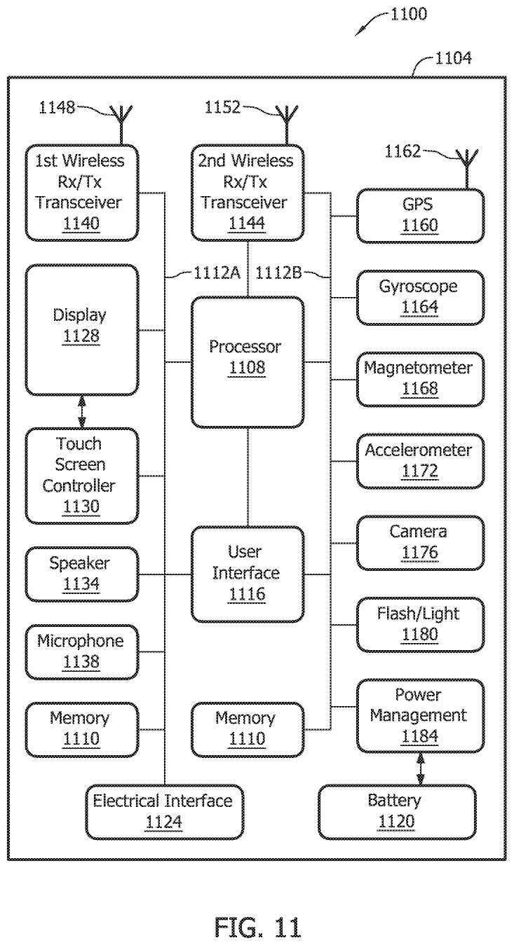

FIG. 11 illustrates an example embodiment of a mobile device 1100, also referred to as a user device or user interacting device, which may or may not be mobile. This is but one possible mobile device 1100 configuration and as such it is contemplated that one of ordinary skill in the art may differently configure the mobile device 1100. The mobile device 1100 may comprise any type of mobile communication device capable of performing as described below. The mobile device 100 may comprise a PDA, cellular telephone, smart phone, tablet PC, wireless electronic pad, an IoT device, a “wearable” electronic device or any other user interacting device.

In this example embodiment, the mobile device 1100 is configured with an outer housing 1104 configured to protect and contain the components described below. Within the housing 1104 is a processor 1108 and a first and second bus 1112A, 1112B (collectively 1112). The processor 1108 communicates over the buses 1112 with the other components of the mobile device 1100. The processor 1108 may comprise any type processor or controller capable of performing as described herein. The processor 1108 may comprise a general purpose processor, ASIC, ARM, DSP, controller, or any other type processing device. The processor 1108 and other elements of the mobile device 1100 receive power from a battery 1120 or other power source. An electrical interface 1124 provides one or more electrical ports to electrically interface with the mobile device 1100, such as with a second electronic device, computer, a medical device, or a power supply/charging device. The interface 1124 may comprise any type electrical interface or connector format.

One or more memories 1110 are part of the mobile device 1100 for storage of machine readable code for execution on the processor 1108 and for storage of data, such as image data, audio data, user data, location data, accelerometer data, or any other type of data. The memory 1110 may comprise RAM, ROM, flash memory, optical memory, or micro-drive memory. The machine readable code (software modules and/or routines) as described herein is non-transitory.

As part of this embodiment, the processor 1108 connects to a user interface 1116. The user interface 1116 may comprise any system or device configured to accept user input to control the mobile device 1100. The user interface 1116 may comprise one or more of the following: microphone, keyboard, roller ball, buttons, wheels, pointer key, touch pad, and touch screen. A touch screen controller 1130 is also provided which interfaces through the bus 1112 and connects to a display 1128.

The display comprises any type display screen configured to display visual information to the user. The screen may comprise a LED, LCD, thin film transistor screen, OEL CSTN (color super twisted nematic), TFT (thin film transistor), TFD (thin film diode), OLED (organic light-emitting diode), AMOLED display (active-matrix organic light-emitting diode), capacitive touch screen, resistive touch screen or any combination of these technologies. The display 1128 receives signals from the processor 1108 and these signals are translated by the display into text and images as is understood in the art. The display 1128 may further comprise a display processor (not shown) or controller that interfaces with the processor 1108. The touch screen controller 1130 may comprise a module configured to receive signals from a touch screen which is overlaid on the display 1128.

Also part of this exemplary mobile device 1100 is a speaker 1134 and microphone 1138. The speaker 1134 and microphone 1138 may be controlled by the processor 1108. The microphone 1138 is configured to receive and convert audio signals to electrical signals based on processor 1108 control. Likewise, the processor 1108 may activate the speaker 1134 to generate audio signals. These devices operate as is understood in the art and as such are not described in detail herein.

Also connected to one or more of the buses 1112 is a first wireless transceiver 1140 and a second wireless transceiver 1144, each of which connect to respective antennas 1148, 1152. The first and second transceiver 1140, 1144 are configured to receive incoming signals from a remote transmitter and perform analog frontend processing on the signals to generate analog baseband signals. The incoming signal maybe further processed by conversion to a digital format, such as by an analog to digital converter, for subsequent processing by the processor 1108. Likewise, the first and second transceiver 1140, 1144 are configured to receive outgoing signals from the processor 1108, or another component of the mobile device 1100, and up convert these signals from baseband to RF frequency for transmission over the respective antenna 1148, 1152. Although shown with a first wireless transceiver 1140 and a second wireless transceiver 1144, it is contemplated that the mobile device 1100 may have only one such system or two or more transceivers. For example, some devices are tri-band or quad-band capable, or have Bluetooth®, NFC, or other communication capability.

It is contemplated that the mobile device 1100, and hence the first wireless transceiver 1140 and a second wireless transceiver 1144 may be configured to operate according to any presently existing or future developed wireless standard including, but not limited to, Bluetooth, WI-FI such as IEEE 802.11 a,b,g,n, wireless LAN, WMAN, broadband fixed access, WiMAX, any cellular technology including CDMA, GSM, EDGE, 3G, 4G, 5G, TDMA, AMPS, FRS, GMRS, citizen band radio, VHF, AM, FM, and wireless USB.

Also part of the mobile device 1100 is one or more systems connected to the second bus 1112B which also interface with the processor 1108. These devices include a global positioning system (GPS) module 1160 with associated antenna 1162. The GPS module 1160 is capable of receiving and processing signals from satellites or other transponders to generate location data regarding the location, direction of travel, and speed of the GPS module 1160. GPS is generally understood in the art and hence not described in detail herein. A gyroscope 1164 connects to the bus 1112B to generate and provide orientation data regarding the orientation of the mobile device 1100. A magnetometer 1168 is provided to provide directional information to the mobile device 1100. An accelerometer 1172 connects to the bus 1112B to provide information or data regarding shocks or forces experienced by the mobile device 1100. In one configuration, the accelerometer 1172 and gyroscope 1164 generate and provide data to the processor 1108 to indicate a movement path and orientation of the mobile device 1100.

One or more cameras (still, video, or both) 1176 are provided to capture image data for storage in the memory 1110 and/or for possible transmission over a wireless or wired link or for viewing at a later time. The one or more cameras 1176 may be configured to detect an image using visible light and/or near-infrared light. The cameras 1176 may also be configured to utilize image intensification, active illumination, or thermal vision to obtain images in dark environments. The processor 1108 may process machine readable code that is stored on the memory to perform the functions described herein.

A flasher and/or flashlight 1180, such as an LED light, are provided and are processor controllable. The flasher or flashlight 1180 may serve as a strobe or traditional flashlight. The flasher or flashlight 1180 may also be configured to emit near-infrared light. A power management module 1184 interfaces with or monitors the battery 1120 to manage power consumption, control battery charging, and provide supply voltages to the various devices which may require different power requirements.

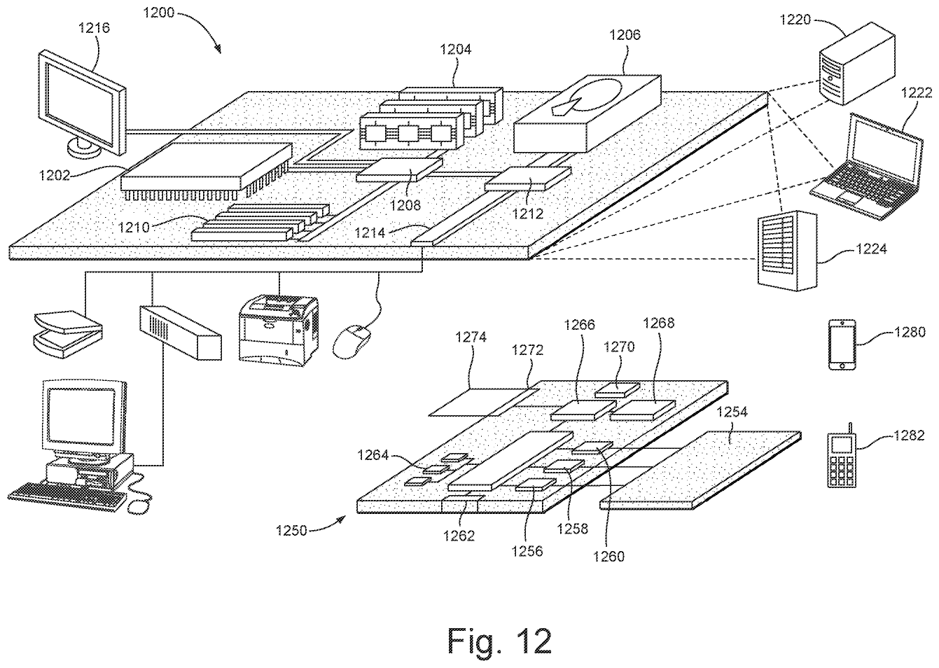

FIG. 12 is a schematic of a computing or mobile device, or server, such as one of the devices described above, according to one exemplary embodiment. User interacting device 1200 is intended to represent various forms of digital computers, such as smartphones, tablets, kiosks, laptops, desktops, workstations, personal digital assistants, servers, blade servers, mainframes, and other appropriate computers. User interacting device 1250 is intended to represent various forms of mobile devices, such as personal digital assistants, cellular telephones, smart phones, and other similar user interacting devices. The components shown here, their connections and relationships, and their functions, are meant to be exemplary only, and are not meant to limit the implementations described and/or claimed in this document.

User interacting device 1200 includes a processor 1202, memory 1204, a storage device 1206, a high-speed interface or controller 1208 connecting to memory 1204 and high-speed expansion ports 1210, and a low-speed interface or controller 1212 connecting to low-speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the user interacting device 1200, including instructions stored in the memory 1204 or on the storage device 1206 to display graphical information for a GUI on an external input/output device, such as display 1216 coupled to high-speed controller 1208. In other implementations, multiple processors and/or multiple buses may be used, as appropriate, along with multiple memories and types of memory. Also, multiple user interacting devices 1200 may be connected, with each device providing portions of the necessary operations (e.g., as a server bank, a group of blade servers, or a multi-processor system).

The memory 1204 stores information within the user interacting device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk.

The storage device 1206 is capable of providing mass storage for the user interacting device 1200. In one implementation, the storage device 1206 may be or contain a computer-readable medium, such as a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, or memory on processor 1202.

The high-speed controller 1208 manages bandwidth-intensive operations for the user interacting device 1200, while the low-speed controller 1212 manages lower bandwidth-intensive operations. Such allocation of functions is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed bus 1214. The low-speed bus 1214, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The user interacting device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from user interacting device 1200 may be combined with other components in a mobile device (not shown), such as device 1250. Each of such devices may contain one or more of user interacting device 1200, 1250, and an entire system may be made up of multiple user interacting devices 1200, 1250 communicating with each other.

User interacting device 1250 includes a processor 1252, memory 1264, an input/output device such as a display 1254, a communication interface 1266, and a transceiver 1268, among other components. The device 1250 may also be provided with a storage device, such as a micro-drive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the user interacting device 1250, including instructions stored in the memory 1264. The processor may be implemented as a chipset of chips that include separate and multiple analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT LCD (Thin-Film-Transistor Liquid Crystal Display) or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provide in communication with processor 1252, to enable near area communication of device 1250 with other devices. External interface 1262 may provide, for example, for wired communication in some implementations, or for wireless communication in other implementations, and multiple interfaces may also be used.

The memory 1264 stores information within the user interacting device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above and may include secure information also. Thus, for example, expansion memory 1274 may be provide as a security module for device 1250 and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252, that may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, Wi-Fi, or other such transceiver (not shown). In addition, GPS (Global Positioning system) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The user interacting device 1250 may be implemented in a number of different forms, as shown in the figure. For example, it may be implemented as a cellular telephone 1260. It may also be implemented as part of a smart phone 1282, personal digital assistant, a computer tablet, or other similar mobile device.

Thus, various implementations of the systems and techniques described here can be realized in digital electronic circuitry, integrated circuitry, especially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, joystick, trackball, or similar device) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system (e.g., user interacting device 1200 and/or 1250) that includes a back end component (e.g., as a data server, slot accounting system, player tracking system, or similar), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An artificial intelligence mechanical device comprising:
a clasp, configured to support a user interacting device, configured to expand and collapse against the user interacting device such that the user interacting device is removable from the clasp, the user interacting device configured to receive a user input from a user and convert the user input to a service request using artificial intelligence services operating on the user interacting device;
a movable mount, connected to the clasp, the movable mount having one or more motors configured impart motion to the movable mount and the user interacting device;
a memory configured with non-transitory machine executable code;
a processor configured to execute the machine executable code stored on the memory, the machine executable code configured to:
receive the service request via a communication link;
convert the service request into movement commands; and
execute the movement commands using the imparted motion to satisfy the service request.

2. The artificial intelligence mechanical device of claim 1 wherein the clasp is mounted on a multi-joint mechanical arm configured to impart motion along one or more different movement axis.

3. The artificial intelligence mechanical device of claim 1 wherein the user interacting device comprising a smartphone, a tablet, a laptop, a personal computer, or a computing device.

4. The artificial intelligence mechanical device of claim 1 further comprising a user interface to receive a second user input, and the machine executable code further configured convert the second user input to a second service request and convert the second service request into movement commands.

5. The artificial intelligence mechanical device of claim 1 wherein the artificial intelligence services comprise one or more of image modelling, text modelling, forecasting, planning, making recommendations, performing searches, processing speech into service requests, processing audio into service requests, processing video into service requests, processing image into service requests, facial recognition, motion detection, motion tracking, generating audio, generating text, generating image, and generating video.

6. The artificial intelligence mechanical device of claim 1 wherein the user input being in an audio format or a video format.

7. The artificial intelligence mechanical device of claim 6 wherein the user input being in a video format received via a camera of the user interacting device, and the imparted motion comprising moving the user interacting device such that a screen of the user interacting device faces the user as the user moves in relation to the camera.

8. A method of controlling the movement of a user interacting device using artificial intelligence comprising:
receiving a user input from a user to a user interacting device;
converting the user input to a service request using artificial intelligence services;
converting the service request into movement commands; and
executing the movement commands to move the user interacting device to satisfy the service request.

9. The method of claim 8 wherein executing the movement commands to satisfy the service comprising movement along at least a first movement axis and a second movement axis.

10. The method of claim 8 wherein the user input being in an audio format or in a video format.

11. The method of claim 10 further comprising executing the movement commands by moving the user interacting device such that a screen of the user interacting device faces the user as the user moves in relation to a camera of the user interacting device.

12. The method of claim 10 further comprising executing the movement commands by moving the user interacting device such that the user interacting device mirrors the user's movement.

13. The method of claim 8 where the artificial intelligence services comprise image modelling, text modelling, forecasting, planning, making recommendations, performing searches, processing speech into service requests, processing audio into service requests, processing video into service requests, processing image into service requests, facial recognition, motion detection, motion tracking, generating audio, generating text, generating image, and generating video.

14. An artificial intelligence mechanical control device, for use with a user interacting device, comprising:
a movable mount, for supporting the user interacting device, on a base;
the base, comprising one or more motors, configured impart motion to the movable mount and the user interacting device;
a user interface configured to receive input from a user and provide results to the user;
a memory within the artificial intelligence mechanical control device configured with non-transitory machine executable code;
a processor within the artificial intelligence mechanical control device configured to execute the machine executable code stored on the memory, the machine executable code configured to:
convert the input from the user to a service request;
convert the service request into movement commands; and
execute the movement commands to move the movable mount, using the one or more motors, to satisfy the service request.

15. The device of claim 14 further comprising a clasp, configured to support the user interacting device, the clasp configured to expand and collapse against the user interacting device such that the user interacting device is removable from the clasp.

16. The device of claim 14 wherein the clasp is mounted on a multi-joint mechanical arm, the multi-joint mechanical arm capable of movement along a first movement axis and a second movement axis.

17. The device of claim 14 wherein the movable mount is configured to move the user interacting device in two different axis of movement.

18. The device of claim 14 wherein the user interacting device is permanently connected to the movable mount.

19. The device of claim 14 wherein the input being in an audio format or a video format.

20. The device of claim 19 wherein the input is in a video format received via a camera of the user interacting device, and the devices moves a screen of the user interacting device to face the user as the user moves in relation to the camera to satisfy the service request.
